(19) United States
(12) Patent Application Publication
(10) Pub. No.: US 2007/0110180 A1
(43) Pub. Date: May 17, 2007

(54) Configurable bit interleaving

(75) Inventors: Joachim S. Hammerschmidt, Mountain View, CA (US); Ling Su, Cupertino, CA (US)

Correspondence Address: GARLICK HARRISON & MARKISON, P.O. BOX 160727, AUSTIN, TX, 78716-0727, US

(73) Assignee: Broadcom Corporation, a California Corporation, Irvine, CA (US)

(21) Appl. No.: 11/595,646

(22) Filed: Nov. 11, 2006

Related U.S. Application Data
(60) Provisional application No. 60/735,501, filed on Nov. 11, 2005.

(51) Int. Cl. H04L 1/02

(52) U.S. Cl. 375/267

(57) ABSTRACT

An integrated circuit radio transceiver and method therefor is operable to flexibly and efficiently interleave a digital bit stream arranged in a table characterized by N rows and N columns further including interleaving column and row bits in the table and frequency rotating interleaved bits in one interleaving step by extracting bits beginning at a row and column offset value specified for the table wherein the first extracted bit is not the first stored bit in the table. Subsequently, the transceiver and method are operable to swizzle interleaved and frequency rotated data bits extracted from the table. In one embodiment, the swizzling begins at a selectable and specified phase value. Further, a stream parser is configurable to produce any number of output streams based upon any number of input streams.

### CROSS REFERENCE TO RELATED APPLICATIONS

This application claims priority to and the benefit of U.S. Provisional Application under 35 U.S.C. 119(e) having a Ser. No. of 60/735,501 and a filing date of Nov. 11, 2005, which is incorporated herein by reference for all purposes. This application also is related to and incorporates by reference the co-pending application having attorney docket number BP5135.1, a Ser. No. of ______ and a title of “Configurable Bit De-Interleaving” by the same inventors as the present application.

### BACKGROUND

1. Technical Field

The present invention relates to wireless communications and, more particularly, to circuitry for generating outgoing communication signals.

2. Related Art

Communication systems are known to support wireless and wire lined communications between wireless and/or wire lined communication devices. Such communication systems range from national and/or international cellular telephone systems to the Internet to point-to-point in-home wireless networks. Each type of communication system is constructed, and hence operates, in accordance with one or more communication standards. For instance, wireless communication systems may operate in accordance with one or more standards, including, but not limited to, IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), and/or variations thereof.

Depending on the type of wireless communication system, a wireless communication device, such as a cellular telephone, two-way radio, personal digital assistant (PDA), personal computer (PC), laptop computer, home entertainment equipment, etc., communicates directly or indirectly with other wireless communication devices. For direct communications (also known as point-to-point communications), the participating wireless communication devices tune their receivers and transmitters to the same channel or channels (e.g., one of a plurality of radio frequency (RF) carriers of the wireless communication system) and communicate over that channel(s). For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via a public switch telephone network (PSTN), via the Internet, and/or via some other wide area network.

Each wireless communication device includes a built-in radio transceiver (i.e., receiver and transmitter) or is coupled to an associated radio transceiver (e.g., a station for in-home and/or in-building wireless communication networks, RF modem, etc.). As is known, the transmitter includes a data modulation stage, one or more intermediate frequency stages, and a power amplifier stage. The data modulation stage converts raw data into baseband signals in accordance with the particular wireless communication standard. The one or more intermediate frequency stages mix the baseband signals with one or more local oscillations to produce RF signals. The power amplifier stage amplifies the RF signals prior to transmission via an antenna.

The data modulation stage is often implemented on a baseband processor or signal processing chip, while frequency conversion stages and power amplifier stages are implemented on a separate radio processor chip. Historically, radio integrated circuits have been designed using bi-polar circuitry, allowing for large signal swings and linear transmitter component behavior. Therefore, many legacy baseband processors employ analog interfaces that communicate analog signals to and from the radio processor.

One common technique for enhancing communications is to modify an order of related bits (interleave the bits) that collectively define a value or term to minimize effects of interference. For example, permutation of the order of bits in a given bit stream may result in consecutive bits lost to interference being from a plurality of data packets such that only one bit or very few bits are lost from a single data packet. By interleaving bits to distribute lost bits within a data packet, the likelihood that error detection/correction techniques are able reconstruct the represented values or terms is enhanced.

To provide a simple illustration of interleaving, five bits received with the following values 01101 may be interleaved and transmitted as 11010. Thus, the order of bits received (1-5) are transmitted in the order of 3, 5, 1, 2, 4. While merely changing the order of five bits may not provide notable advantage, interleaving can be advantageous when bits of a data packet are spread out in relation to each other. It should be understood that a substantially greater number of bits (i.e.; the bits of a four micro-second frame) are interleaved in this manner. Five bits are used herein merely to provide a simple example.

Along these lines, interleaving may desirably be applied to MIMO type communication devices in which a plurality of outgoing signal paths carry a plurality of outgoing data streams. While there exists a need for specific implementations for multi-branch interleaving, there is a further need for developing interleaving methodologies that are configurable and flexible.

### SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

A better understanding of the present invention can be obtained when the following detailed description of the preferred embodiment is considered with the following drawings, in which:

FIG. 1 is a functional block diagram illustrating a communication system that includes circuit devices and network elements and operation thereof according to one embodiment of the invention.

FIG. 2 is a schematic block diagram illustrating a wireless communication host device and an associated radio;

FIG. 3 is a schematic block diagram illustrating a wireless communication device that includes a host device and an associated radio;

FIG. 4 is a functional block diagram of a wireless orthogonal frequency division multiplex (OFDM) transmitter processor that includes a multi-stream bit interleaver according to one embodiment of the invention;

FIG. 5 is a functional block diagram of a configurable stream parser and frequency interleaver according to an embodiment of the invention;

FIG. 6 is a table that illustrates a method for interleaving according to one embodiment of the invention;

FIG. 7 is a functional process block diagram that illustrates interleaving according to the embodiments of the present invention;

FIG. 8 is a functional block diagram that illustrates the first embodiment of phase determination for a swizzling block;

FIG. 9 is a functional block diagram of a second embodiment of the invention for phase determination for a swizzling block;

FIG. 10 is a functional block diagram that illustrates an interleaver system 200 and control logic therefor according to one embodiment of the present invention;

FIGS. 11A and 11B are interleaving configuration tables that illustrate two methods according to various embodiments of the present invention for performing row/column offset interleaving for a single or an OFDM transmission scheme;

FIG. 12 is a functional block diagram of an interleaver control system according to one embodiment of the invention;

FIG. 13 is a functional block diagram of a stream parser operating according to one embodiment of the present invention;

FIG. 14 is an exemplary block diagram of a stream parser and interleaver according to one embodiment of the invention;

FIG. 15 is a block diagram of a destination based control system according to one embodiment of the invention;

FIGS. 16A and 16B are source tables for destination based control according various embodiments of the invention;

FIG. 17 is a block diagram of a source based control system according to one embodiment of the invention;

FIGS. 18A and 18B are destination tables for destination based control according various embodiments of the invention;

FIG. 19 is an exemplary stream parser configuration table according to one embodiment of the invention,

FIG. 20 is a flow chart that illustrates a method for interleaving according to one embodiment of the invention; and

FIG. 21 is a flow chart that illustrates a method for interleaving according to one embodiment of the invention.

### DETAILED DESCRIPTION OF THE DRAWINGS

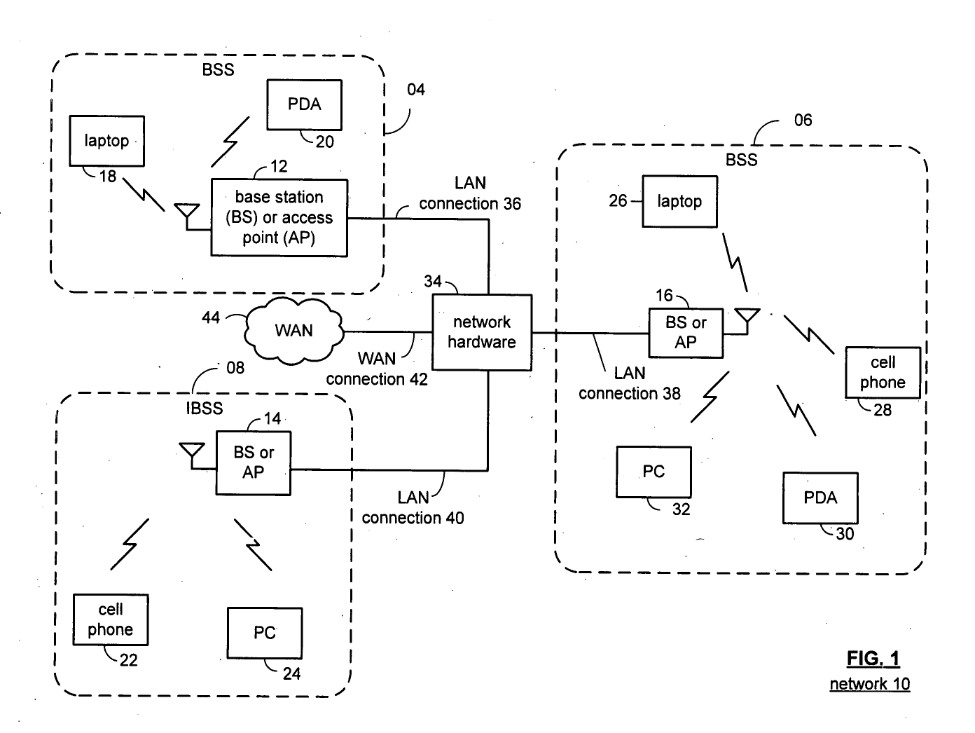

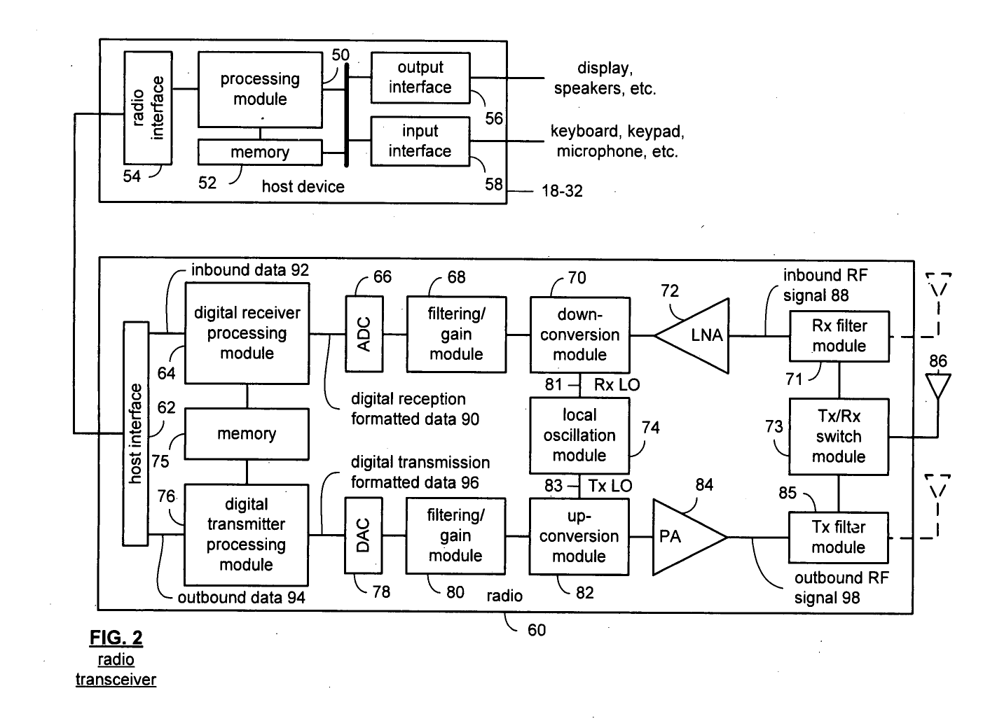

FIG. 1 is a functional block diagram illustrating a communication system that includes circuit devices and network elements and operation thereof according to one embodiment of the invention. More specifically, a plurality of network service areas 04, 06 and 08 are a part of a network 10. Network 10 includes a plurality of base stations or access points (APs) 12-16, a plurality of wireless communication devices 18-32 and a network hardware component 34. The wireless communication devices 18-32 may be laptop computers 18 and 26, personal digital assistants 20 and 30, personal computers 24 and 32 and/or cellular telephones 22 and 28. The details of the wireless communication devices will be described in greater detail with reference to FIGS. 2-10.

The base stations or APs 12-16 are operably coupled to the network hardware component 34 via local area network (LAN) connections 36, 38 and 40. The network hardware component 34, which may be a router, switch, bridge, modem, system controller, etc., provides a wide area network (WAN) connection 42 for the communication system 10 to an external network element such as WAN 44. Each of the base stations or access points 12-16 has an associated antenna or antenna array to communicate with the wireless communication devices in its area. Typically, the wireless communication devices 18-32 register with the particular base station or access points 12-16 to receive services from the communication system 10. For direct connections (i.e., point-to-point communications), wireless communication devices communicate directly via an allocated channel.

Typically, base stations are used for cellular telephone systems and like-type systems, while access points are used for in-home or in-building wireless networks. Regardless of the particular type of communication system, each wireless communication device includes a built-in radio and/or is coupled to a radio.

FIG. 2 is a schematic block diagram illustrating a wireless communication host device 18-32 and an associated radio 60. For cellular telephone hosts, radio 60 is a built-in component. For personal digital assistants hosts, laptop hosts, and/or personal computer hosts, the radio 60 may be built-in or an externally coupled component.

As illustrated, wireless communication host device 18-32 includes a processing module 50, a memory 52, a radio interface 54, an input interface 58 and an output interface 56. Processing module 50 and memory 52 execute the corresponding instructions that are typically done by the host device. For example, for a cellular telephone host device, processing module 50 performs the corresponding communication functions in accordance with a particular cellular telephone standard.

Radio interface 54 allows data to be received from and sent to radio 60. For data received from radio 60 (e.g., inbound data), radio interface 54 provides the data to processing module 50 for further processing and/or routing to output interface 56. Output interface 56 provides connectivity to an output device such as a display, monitor, speakers, etc., such that the received data may be displayed. Radio interface 54 also provides data from processing module 50 to radio 60. Processing module 50 may receive the outbound data from an input device such as a keyboard, keypad, microphone, etc., via input interface 58 or generate the data itself. For data received via input interface 58, processing module 50 may perform a corresponding host function on the data and/or route it to radio 60 via radio interface 54.

Radio 60 includes a host interface 62, a digital receiver processing module 64, an analog-to-digital converter 66, a filtering/gain module 68, a down-conversion module 70, a low noise amplifier 72, a receiver filter module 71, a transmitter/receiver (Tx/Rx) switch module 73, a local oscillation module 74, a memory 75, a digital transmitter processing module 76, a digital-to-analog converter 78, a filtering/gain module 80, an up-conversion module 82, a power amplifier 84, a transmitter filter module 85, and an antenna 86 operatively coupled as shown. The antenna 86 is shared by the transmit and receive paths as regulated by the Tx/Rx switch module 73. The antenna implementation will depend on the particular standard to which the wireless communication device is compliant.

Digital receiver processing module 64 and digital transmitter processing module 76, in combination with operational instructions stored in memory 75, execute digital receiver functions and digital transmitter functions, respectively. The digital receiver functions include, but are not limited to, demodulation, constellation demapping, decoding, and/or descrambling. The digital transmitter functions include, but are not limited to, scrambling, encoding, constellation mapping, and modulation. Digital receiver and transmitter processing modules 64 and 76, respectively, may be implemented using a shared processing device, individual processing devices, or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions.

Memory 75 may be a single memory device or a plurality of memory devices. Such a memory device may be a read-only memory, random access memory, volatile memory, non-volatile memory, static memory, dynamic memory, flash memory, and/or any device that stores digital information. Note that when digital receiver processing module 64 and/or digital transmitter processing module 76 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry. Memory 75 stores, and digital receiver processing module 64 and/or digital transmitter processing module 76 executes, operational instructions corresponding to at least some of the functions illustrated herein.

In operation, radio 60 receives outbound data 94 from wireless communication host device 18-32 via host interface 62. Host interface 62 routes outbound data 94 to digital transmitter processing module 76, which processes outbound data 94 in accordance with a particular wireless communication standard or protocol (e.g., IEEE 802.11(a), IEEE 802.11b, Bluetooth, etc.) to produce digital transmission formatted data 96. Digital transmission formatted data 96 will be a digital baseband signal or a digital low IF signal, where the low IF typically will be in the frequency range of one hundred kilohertz to a few megahertz.

Digital-to-analog converter 78 converts digital transmission formatted data 96 from the digital domain to the analog domain. Filtering/gain module 80 filters and/or adjusts the gain of the analog baseband signal prior to providing it to up-conversion module 82. Up-conversion module 82 directly converts the analog baseband signal, or low IF signal, into an RF signal based on a transmitter local oscillation 83 provided by local oscillation module 74. Power amplifier 84 amplifies the RF signal to produce an outbound RF signal 98, which is filtered by transmitter filter module 85. The antenna 86 transmits outbound RF signal 98 to a targeted device such as a base station, an access point and/or another wireless communication device.

Radio 60 also receives an inbound RF signal 88 via antenna 86, which was transmitted by a base station, an access point, or another wireless communication device. The antenna 86 provides inbound RF signal 88 to receiver filter module 71 via Tx/Rx switch module 73, where Rx filter module 71 bandpass filters inbound RF signal 88. The Rx filter module 71 provides the filtered RF signal to low noise amplifier 72, which amplifies inbound RF signal 88 to produce an amplified inbound RF signal. Low noise amplifier 72 provides the amplified inbound RF signal to down-conversion module 70, which directly converts the amplified inbound RF signal into an inbound low IF signal or baseband signal based on a receiver local oscillation 81 provided by local oscillation module 74. Down-conversion module 70 provides the inbound low IF signal or baseband signal to filtering/gain module 68. Filtering/gain module 68 may be implemented in accordance with the teachings of the present invention to filter and/or attenuate the inbound low IF signal or the inbound baseband signal to produce a filtered inbound signal.

Analog-to-digital converter 66 converts the filtered inbound signal from the analog domain to the digital domain to produce digital reception formatted data 90. Digital receiver processing module 64 decodes, descrambles, demaps, and/or demodulates digital reception formatted data 90 to recapture inbound data 92 in accordance with the particular wireless communication standard being implemented by radio 60. Host interface 62 provides the recaptured inbound data 92 to the wireless communication host device 18-32 via radio interface 54.

As one of average skill in the art will appreciate, the wireless communication device of FIG. 2 may be implemented using one or more integrated circuits. For example, the host device may be implemented on a first integrated circuit, while digital receiver processing module 64, digital transmitter processing module 76 and memory 75 may be implemented on a second integrated circuit, and the remaining components of radio 60, less antenna 86, may be implemented on a third integrated circuit. As an alternate example, radio 60 may be implemented on a single integrated circuit. As yet another example, processing module 50 of the host device and digital receiver processing module 64 and digital transmitter processing module 76 may be a common processing device implemented on a single integrated circuit.

Memory 52 and memory 75 may be implemented on a single integrated circuit and/or on the same integrated circuit as the common processing modules of processing module 50, digital receiver processing module 64, and digital transmitter processing module 76. As will be described, it is important that accurate oscillation signals are provided to mixers and conversion modules. A source of oscillation error is noise coupled into oscillation circuitry through integrated circuitry biasing circuitry. One embodiment of the present invention reduces the noise by providing a selectable pole low pass filter in current mirror devices formed within the one or more integrated circuits.

Local oscillation module 74 includes circuitry for adjusting an output frequency of a local oscillation signal provided therefrom. Local oscillation module 74 receives a frequency correction input that it uses to adjust an output local oscillation signal to produce a frequency corrected local oscillation signal output. While local oscillation module 74, up-conversion module 82 and down-conversion module 70 are implemented to perform direct conversion between baseband and RF, it is understood that the principles herein may also be applied readily to systems that implement an intermediate frequency conversion step at a low intermediate frequency.

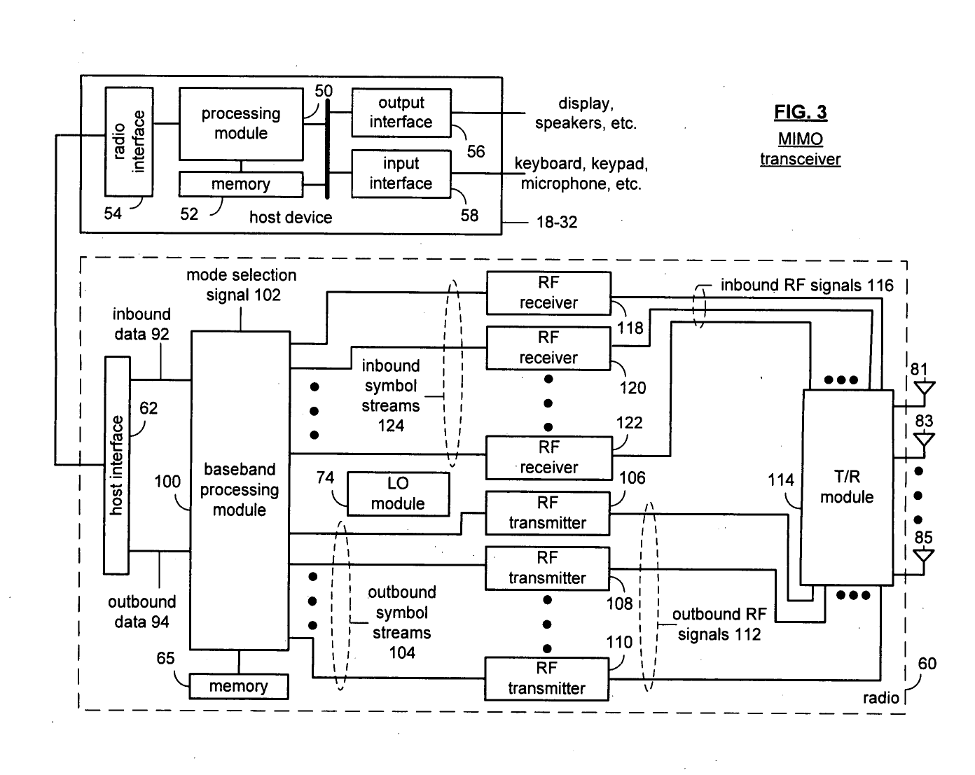

FIG. 3 is a schematic block diagram illustrating a wireless communication device that includes the host device 18-32 and an associated radio 60. For cellular telephone hosts, the radio 60 is a built-in component. For personal digital assistants hosts, laptop hosts, and/or personal computer hosts, the radio 60 may be built-in or an externally coupled component.

As illustrated, the host device 18-32 includes a processing module 50, memory 52, radio interface 54, input interface 58 and output interface 56. The processing module 50 and memory 52 execute the corresponding instructions that are typically done by the host device. For example, for a cellular telephone host device, the processing module 50 performs the corresponding communication functions in accordance with a particular cellular telephone standard.

The radio interface 54 allows data to be received from and sent to the radio 60. For data received from the radio 60 (e.g., inbound data), the radio interface 54 provides the data to the processing module 50 for further processing and/or routing to the output interface 56. The output interface 56 provides connectivity to an output display device such as a display, monitor, speakers, etc., such that the received data may be displayed. The radio interface 54 also provides data from the processing module 50 to the radio 60. The processing module 50 may receive the outbound data from an input device such as a keyboard, keypad, microphone, etc., via the input interface 58 or generate the data itself. For data received via the input interface 58, the processing module 50 may perform a corresponding host function on the data and/or route it to the radio 60 via the radio interface 54.

Radio 60 includes a host interface 62, a baseband processing module 100, memory 65, a plurality of radio frequency (RF) transmitters 106-110, a transmit/receive (T/R) module 114, a plurality of antennas 81-85, a plurality of RF receivers 118-120, and a local oscillation module 74. The baseband processing module 100, in combination with operational instructions stored in memory 65, executes digital receiver functions and digital transmitter functions, respectively. The digital receiver functions include, but are not limited to, digital intermediate frequency to baseband conversion, demodulation, constellation demapping, decoding, de-interleaving, fast Fourier transform, cyclic prefix removal, space and time decoding, and/or descrambling. The digital transmitter functions include, but are not limited to, scrambling, encoding, interleaving, constellation mapping, modulation, inverse fast Fourier transform, cyclic prefix addition, space and time encoding, and digital baseband to IF conversion. The baseband processing module 100 may be implemented using one or more processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory 65 may be a single memory device or a plurality of memory devices. Such a memory device may be a read-only memory, random access memory, volatile memory, non-volatile memory, static memory, dynamic memory, flash memory, and/or any device that stores digital information. Note that when the baseband processing module 100 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

In operation, the radio 60 receives outbound data 94 from the host device via the host interface 62. The baseband processing module 100 receives the outbound data 94 and, based on a mode selection signal 102, produces one or more outbound symbol streams 104. The mode selection signal 102 will indicate a particular mode of operation that is compliant with one or more specific modes of the various IEEE 802.11 standards. For example, the mode selection signal 102 may indicate a frequency band of 2.4 GHz, a channel bandwidth of 20 or 22 MHz and a maximum bit rate of 54 megabits-per-second. In this general category, the mode selection signal will further indicate a particular rate ranging from 1 megabit-per-second to 54 megabits-per-second. In addition, the mode selection signal will indicate a particular type of modulation, which includes, but is not limited to, Barker Code Modulation, BPSK, QPSK, CCK, 16 QAM and/or 64 QAM. The mode selection signal 102 may also include a code rate, a number of coded bits per subcarrier (NBPSC), coded bits per OFDM symbol (NCBPS), and/or data bits per OFDM symbol (NDBPS). The mode selection signal 102 may also indicate a particular channelization for the corresponding mode that provides a channel number and corresponding center frequency. The mode selection signal 102 may further indicate a power spectral density mask value and a number of antennas to be initially used for a MIMO communication.

The baseband processing module 100, based on the mode selection signal 102 produces one or more outbound symbol streams 104 from the outbound data 94. For example, if the mode selection signal 102 indicates that a single transmit antenna is being utilized for the particular mode that has been selected, the baseband processing module 100 will produce a single outbound symbol stream 104. Alternatively, if the mode selection signal 102 indicates 2, 3 or 4 antennas, the baseband processing module 100 will produce 2, 3 or 4 outbound symbol streams 104 from the outbound data 94.

Depending on the number of outbound symbol streams 104 produced by the baseband processing module 100, a corresponding number of the RF transmitters 106-110 will be enabled to convert the outbound symbol streams 104 into outbound RF signals 112. In general, each of the RF transmitters 106-110 includes a digital filter and upsampling module, a digital-to-analog conversion module, an analog filter module, a frequency up conversion module, a power amplifier, and a radio frequency bandpass filter. The RF transmitters 106-110 provide the outbound RF signals 112 to the transmit/receive module 114, which provides each outbound RF signal to a corresponding antenna 81-85.

When the radio 60 is in the receive mode, the transmit/receive module 114 receives one or more inbound RF signals 116 via the antennas 81-85 and provides them to one or more RF receivers 118-122. The RF receiver 118-122 converts the inbound RF signals 116 into a corresponding number of inbound symbol streams 124. The number of inbound symbol streams 124 will correspond to the particular mode in which the data was received. The baseband processing module 100 converts the inbound symbol streams 124 into inbound data 92, which is provided to the host device 18-32 via the host interface 62.

As one of average skill in the art will appreciate, the wireless communication device of FIG. 3 may be implemented using one or more integrated circuits. For example, the host device may be implemented on a first integrated circuit, the baseband processing module 100 and memory 65 may be implemented on a second integrated circuit, and the remaining components of the radio 60, less the antennas 81-85, may be implemented on a third integrated circuit. As an alternate example, the radio 60 may be implemented on a single integrated circuit. As yet another example, the processing module 50 of the host device and the baseband processing module 100 may be a common processing device implemented on a single integrated circuit. Further, the memory 52 and memory 65 may be implemented on a single integrated circuit and/or on the same integrated circuit as the common processing modules of processing module 50 and the baseband processing module 100.

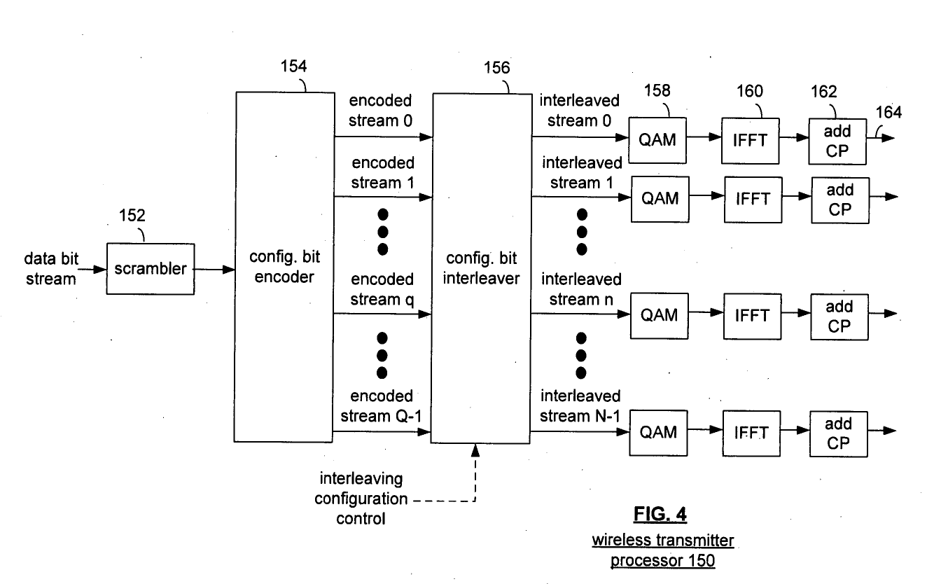

FIG. 4 is a functional block diagram of a wireless orthogonal frequency division multiplex (OFDM) transmitter processor that includes a multi-stream bit interleaver according to one embodiment of the invention. Referring to processor 150 of FIG. 4, a data bit stream is produced to a scrambler 152 where the bits are scrambled according to a specified technique. Scrambler 152 then produces scrambled bits to a configurable bit encoder 154 that encodes the scrambled bits and produces a specified number of encoded data streams. As is known by one of average skill in the art, encoders provide protection for bits to allow a bit stream portion to be reconstructed by a receiver if interference destroyed some of the bits in the transmission path. Here, encoder 154 produces encoded bits streams 0, 1, . . . q, . . . Q−1. Generally, the number of encoded bit streams is a function of the OFDM transmitter and a transmission mode of operation (transmission scheme). Accordingly, encoder 154 produces Q−1 encoded streams to interleaver 156. Interleaver 156, however, produces N−1 interleaved bit streams. The N−1 interleaved bit streams produced by interleaver 156 are interleaved according to the various embodiments of the invention as described herein. The number of streams N−1 produced by interleaver 156 is based upon a received control signal in one embodiment of the invention. Here, in FIG. 4, an interleaving control signal includes an indication of the number of output streams that are produced by interleaver 156.

Thus, each of the N−1 interleaved bit streams produced by interleaver 156 are processed through traditional processor logic blocks in preparation for transmission from a radio front end (not shown in FIG. 4). For example, interleaved bit stream 0 is produced to constellation encoding block 158 which performs specified quadrature amplitude modulation. Any known type of quadrature amplitude modulation may be used. In one embodiment, a traditional QPSK modulation is used. In another embodiment, 16-QAM modulation is used. Other types include, but are not limited to binary phase quadrature modulation (BPSK), 8-PSK, 64-QAM, 128-QAM, and 256-QAM. Constellation encoding is generally performed to increase data rates by generating data symbols that represent a plurality of bits.

Modulation block 158 then produces a modulation encoded signal to inverse Fast Fourier Transform (IFFT) block 160 which is operable to produce an inverse Fast Fourier Transform (IFFT) of the modulation encoded signal 160 to cyclic prefix block 162 which is operable to produce a guard interval for the signal prior to transmission from a radio front end.

The output of the signal with the cyclic prefix is shown at 164. The output at 164 is then produced to the radio front end that filters, amplifies and upconverts the outgoing signal to radio frequency prior to radiation from an antenna. Operation of each of the remaining branches for processing and transmitting the remaining Q−1 bit streams is the same as described for interleaved bit stream 0.

One important aspect of the invention illustrated in FIG. 4 is that interleaver 156 is configurable to perform interleaving across the plurality of bit streams according the number of bit streams being generated for a multi-branch transmitter that is operable to transmit from a plurality of antennas using OFDM modulation. For example, merely because an MIMO transmitter having the circuitry to generate, for example, four OFDM outgoing signals, does not mean that the MIMO transmitter will always transmit over four streams at once. If, for example, a selected transmission mode requires transmission over only two streams, then N−1 is equal to two. Accordingly, bit interleaver 156 receives only two encoded bit streams from encoder 154 and produces only two interleaved bits streams. Significantly, however, bits of each of the two bit streams are interleaved between the two streams in addition to being interleaved amongst the bits of each individual stream. Thus, interleaver 156 is configurable to utilize and includes logic configure the interleaving over a specified number of bit streams according to an interleaving configuration control signal. Generally, configurable bit encoder 154 is operable to produce Q−1 encoded streams to configurable bit interleaver 156. Interleaver 156 is operable to produce N−1 interleaved streams. Thus, the number of interleaved bit streams is based upon a specified value and not necessarily upon the number of encoded streams that are received. This aspect of Interleaver 156 may apply to all embodiments of the invention and is not limited to the embodiment of FIG. 4.

In the described embodiment of the invention, the number of encoded streams received is not necessarily equal to the number of interleaved streams that are produced by configurable bit interleaver 156. Further, the number of input and/or output streams may readily be modified based upon modes of transmission.

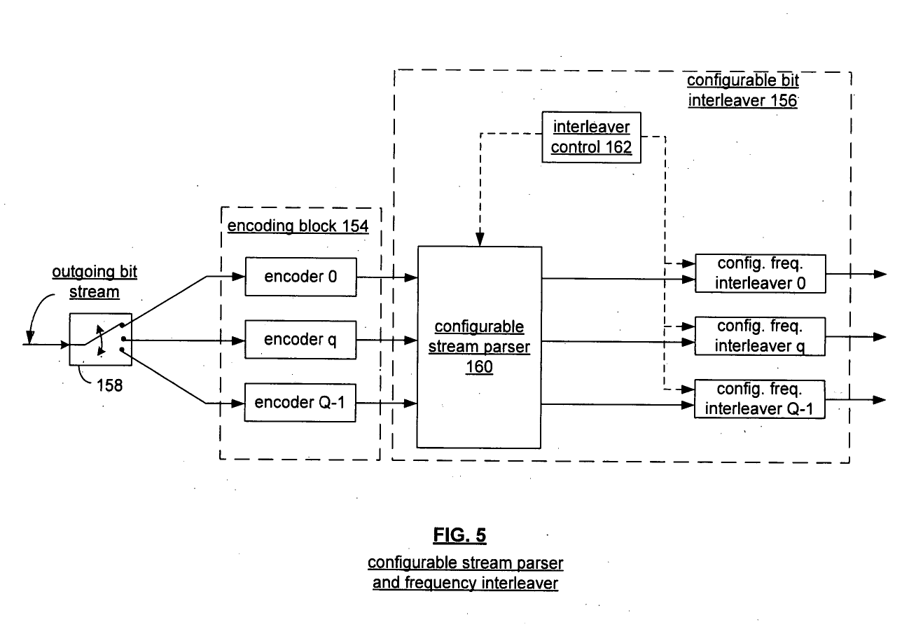

FIG. 5 is a functional block diagram of a configurable stream parser and frequency interleaver according to an embodiment of the invention. Generally, a configurable stream parser in combination with a plurality of configurable frequency interleavers that are operably coupled to a common controller collectively produce a flexible and configurable interleaver system operable to interleave signals across one or more output antennas in an OFDM transmitter according to a transmission mode of operation.

Specifically, an outgoing bit stream is received by a switching block 158 that is operable to distribute the outgoing bit stream. In the example of FIG. 5, block 158 produces three streams to encoding block 154. It should be understood, however, that block 158 is generally operable to produce a number of streams that correspond to a corresponding number of encoders used within encoding block 154 for a particular transmission mode. In one embodiment, block 158 is configurable to alter the number of outgoing streams according to a transmission mode. This embodiment is especially useful for an OFDM transmitter that may transmit from less than all of the outgoing signal paths.

Encoding block 154 produces a plurality of encoded bit streams to a configurable stream parser 160. Parser 160 is configurable to selectively alter the number of output streams produced according to a control command which is received from interleaver control 162. In one embodiment, parser 160 is operable to readily reconfigure itself to parse one or more input streams across two, three, four or more output streams based upon the control signal received from interleaver control 162.

Parser 160 produces parsed output streams to a corresponding plurality of configurable frequency interleavers of configurable bit interleaver 156. Operation of the configurable frequency interleavers according to the various embodiments of the invention will be described in greater detail below. Generally, however, each performs bit interleaving based upon a specified initial storage location and upon a specified initial extraction position (offset position) to achieve interleaving and frequency (block) rotation in one interleaving step.

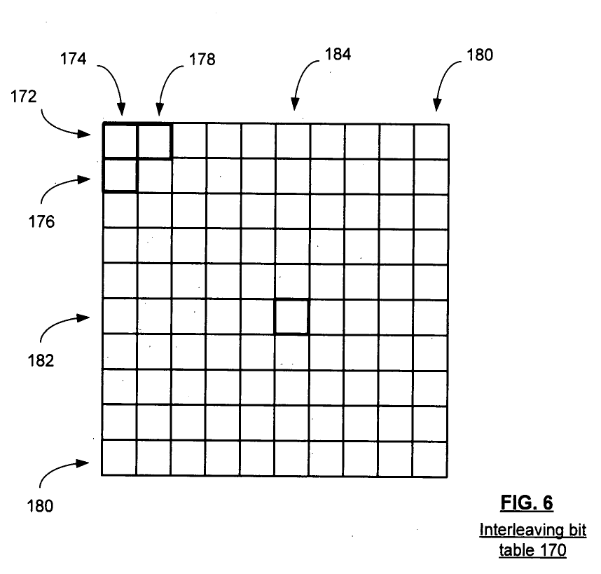

FIG. 6 is a table that illustrates a method for interleaving according to one embodiment of the invention. Generally, the method disclosed herein is a method according to one embodiment that is performed within each of the configurable frequency interleavers of configurable bit interleaver 156 of FIG. 5. Interleaving bit table 170 comprises a plurality of rows and tables used to temporarily hold bits of a bit stream that are to be interleaved. Interleaving is the permutation of the bit order and is used to minimize the effects of noise and transients upon a transmission signal. In effect, interleaving minimizes the number of bits that are lost of a specified byte or packet thereby facilitating the reconstruction and determination of the value of lost bits through known error correction techniques. Thus, bits in the order of 1 2 3 4 5 may be rearranged in the order of 3 5 1 2 4 at the transmission end and then rearranged from 3 5 1 2 4 back to 1 2 3 4 5 at the receiving end. If, for example, a noise transient that eliminates two bits in the center would result in, for example, bits 5 and 1 being eliminated instead of bits 2 and 3. Thus, because non-adjacent bits of the original stream are eliminated instead of adjacent bits, error correction techniques may more readily determine the values of bits 1 and 5.

In a MIMO context in which a plurality of transmissions may occur, it is advantageous to perform interleaving amongst a plurality of spatial streams as well as subcarriers to provide space diversity in addition to frequency diversity for a given bit stream to further eliminate the effects of interference. Thus, when an interleaver operating according to an embodiment of the present invention receives one or more bit streams, the bits are fed into a table as shown in an exemplary manner here in FIG. 6. In one embodiment, a first received bit is stored in the position defined by row 172 and column 174 (top left most comer of the table). A subsequent bit is then stored in row 172, column 178. In a similar manner, each subsequent bit is stored in an adjacent column but in the same row until a row is completely filled. Thereafter, a subsequent bit would be stored in row 176, column 174. More specifically, after a bit is stored in row 172, column 180, a subsequent bit is stored in row 176, column 174.

Thus, bits of a bit stream are stored first by row and then by column in this embodiment. They may, just as easily, be stored first by column and then by row. Traditionally, to produce an interleaved output, bits are read out in an opposite manner. Thus, starting at the same location into which the first bit was stored, bits are read out by column and then by row (if stored by row and then by column). In an alternate embodiment in which the bits were stored first by column and then by row, the bits are read out first by row and then by column. At a receiving end, a similar table is reconstructed to generate the original bit stream in which the bits are de-interleaved. To further understand interleaving according to the embodiments of the present invention, consider FIG. 7. In more general terms bits are stored in a first tabular order beginning at a first specified location and are extracted in a second tabular order beginning at an offset location (a second specified location different from the first specified location). In FIG. 6, such an offset location is shown at row 182, column 184.

FIG. 7 is a functional process block diagram that illustrates interleaving according to the embodiments of the present invention. Specifically, interleaving traditionally includes row and column interleaving as described above in relation to FIG. 6. Here, in FIG. 7, such interleaving is performed by a row and column interleaving block 186. Additionally, interleaving processes typically include bit swizzling in a swizzling block 188 and frequency rotation in a frequency rotation block 190. Bit swizzling comprises rotating (cyclic shifting) a specified block of bits a specified number of times. The number of times the bits are rotated is specified by a rotation parameter defined as the swizzling phase. Block 186 produces an interleaved bit stream to swizzling block 188. Swizzling block 188 produces a swizzled bit stream to frequency rotation block 190. Rotation block 190 then performs a block rotation also known as frequency rotation.

For exemplary purposes, consider the bit stream 011. A bit phase of 0 means no swizzling occurs. A bit phase of one means that bits are rotated once. Thus, if the rotation is counter-clock wise, the output of the swizzling step is 101. Similarly, for a bit phase of 2, the swizzled output is equal to 110. In terms of notation, the block size “s” for the example is 3 since three bits were being swizzled. Typically, the swizzling phase p is kept constant over a given number of blocks of size s, but is taken to the next value after the given number of blocks. Thus, for the present example, the phase rotates from 0 to 1 to 2 and then back to 0 where the rotation continues as described. Referring back to FIG. 6, the starting phase for a first block of bits is equal to zero (i.e., no swizzling). Thus, for the bits initially stored starting in the upper left comer, the swizzling phase is typically equal to zero.

Frequency rotation is similar to swizzling except that an entire block is moved in relation to other blocks. Thus, for a stream of bits that form blocks A B C D E F, one embodiment of frequency rotation comprises re-arranging the blocks as F A B C D E. In an alternate embodiment, the blocks may be re-arranged as C A B F D E wherein the grouping of blocks for rotation is equal to 3 instead of the entire group of blocks. Thus, in alternate embodiment, an entire group of blocks may be subdivided into sub-groups of any size for frequency rotation. In the described embodiments, however, for simplicity, frequency rotation is not subdivided into groups of blocks.

Referring back to FIG. 7, then, it may be seen that one aspect of the invention includes an interleaver 156 that is operable to combine the steps of row and column interleaving with frequency rotation to create a step illustrated as row/col. offset interleaving.

Effectively, both row and column interleaving and frequency rotation are combined in a single step thereby simplifying the process and associated logic complexity. Thus, as is shown, row/col offset interleaving block 192 produces a frequency interleaved output to swizzling block 188.

Block 192 generates the frequency interleaved output in one interleaving step. Referring back to table 170 of FIG. 6, the steps of row and column interleaving along with frequency rotation are performed by initially storing bits in a manner as defined before (in the described embodiment, by starting at the left uppermost location) but by reading out bits from a different starting location defined by an offset value. Thus, in the example of FIG. 6, bits are stored either by row and then by column or by column and then by row starting the location of row 172, column 174. Thereafter, the bits are read out starting, in this example, at the location of row 182, column 184. Thus, if the bits were stored initially by row and then by column, then they are read out by column and then by row starting at row 182, column 184. The offset value, while defined by a starting row and column, represents starting location that is specified by a number of bits from the original starting bit. In the present example, since the table is a 10 by 10 table, the starting location for reading bits defined by row 182, column 184 is equal to an offset of 56 bits. This may be seen by calculating the number of bits to the offset location (5(rows)*10(bits/row)+6(bits)). While the described embodiments include storing the first bit in the left uppermost column, the various embodiments of the invention include storing the bits in any specified location and subsequently extracting or reading out bits from an offset position relative to the starting specified location.

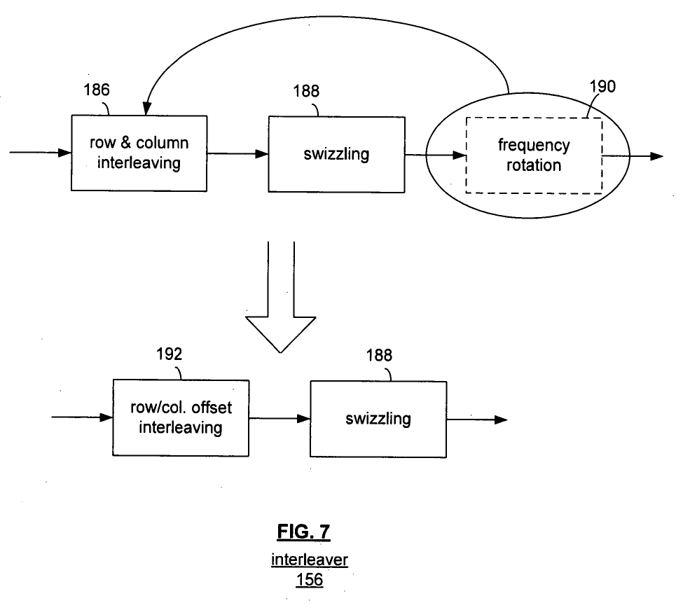

FIG. 8 is a functional block diagram that illustrates the first embodiment of phase determination for a swizzling block. As may be seen, a row/column offset interleaving block 192 produces frequency interleaved bits to a swizzling block 188. Additionally, block 192 produces a signal 194 that provides an indication of a present column from which bits are being extracted and produced to swizzling block188. Accordingly, swizzling block 188 is operable to determine a swizzling phase based upon the indicated column in signal 194 in a specified manner. For example, referring back to FIG. 6, in one embodiment, all bits extracted from column 174 have a swizzling phase of 0 while bits from column 178 have a swizzling phase equal to 1. As bits are read from subsequent adjacent columns, the swizzling phase is incremented to a value of S−1 when S is a size of a block of bits that are being swizzled. Thereafter, when bits are extracted from a subsequent column, the swizzling phase is reset to 0 and the process continues. Referring back to FIG. 8, therefore, the first embodiment of the swizzling phase determination which is performed by swizzling block 188 is based upon the column indication received in signal 194.

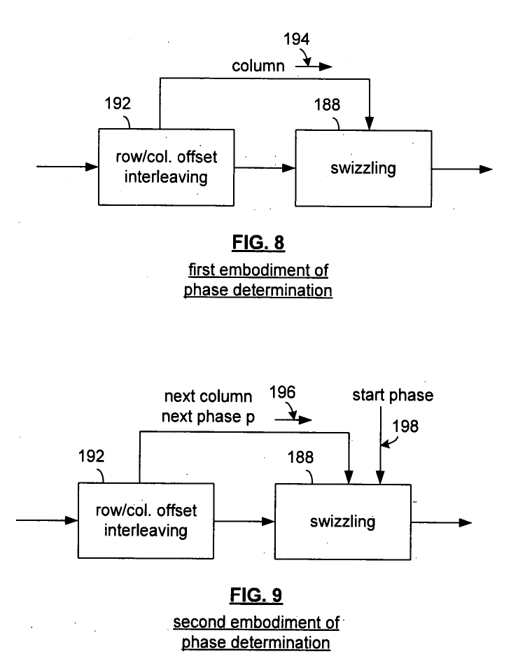

FIG. 9 is a functional block diagram of a second embodiment of the invention for phase determination for a swizzling block. As before, block 192 produces frequency interleaved bits to swizzling block 188. However, block 192 also produces a signal 196 that specifies the a change of column and that the next swizzling phase P should commence. Additionally, swizzling block 188 is operably disposed to receive, from external logic, a starting phase value in a signal 198.

Accordingly, with the embodiment of FIG. 9, block 192 provides relative swizzling phase information based on a change in column location of a bit being extracted while a starting phase value determines the starting phase. As such, the second embodiment of swizzling phase determination of FIG. 9 provides complete flexibility for initiating a starting swizzling phase value. As such, bits extracted initially from a starting from a specified offset location may either be swizzled according to a defined swizzling phase value assigned to the initial column defined by the offset value or alternatively, according to a desired swizzling phase for bits extracted from the column defined by the offset value.

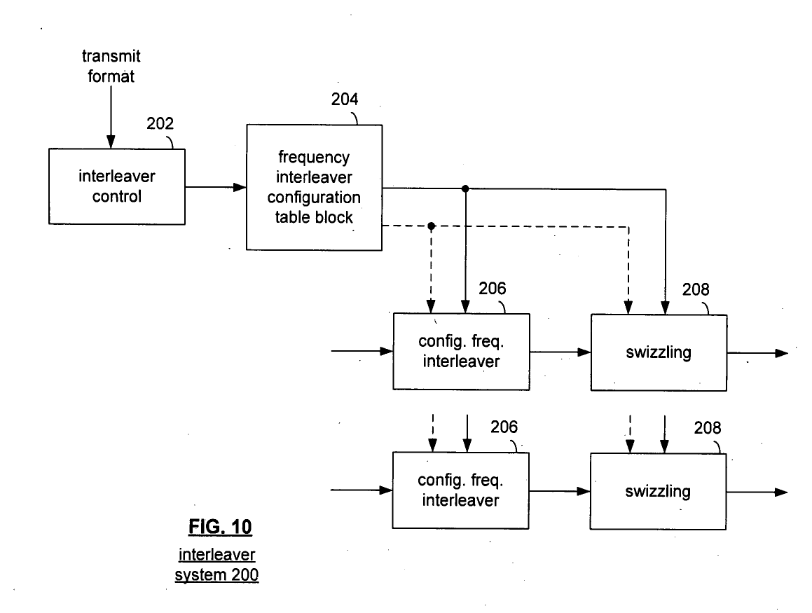

FIG. 10 is a functional block diagram that illustrates an interleaver system 200 and control logic therefor according to one embodiment of the present invention. Interleaver system 200 includes an interleaver control logic 202 that is operably coupled to produce control signals to frequency interleaver configuration table block 204. Each of the configurable frequency interleavers and swizzling blocks, however, operate based upon frequency interleaver configuration tables and control signals received from the frequency interleaver configuration table block 204. What table is produced by frequency interleaver configuration table block 204 is based upon a control signal received from interleaver control block 202.

Interleaver control block 202 produces a control signal to frequency interleaver configuration table block 204 based upon a transmission format signal specified by a received signal that specified a current transmission format. Generally, especially in an OFDM compatible transmitter, the transmission format may vary from transmission from a single antenna to transmission on a plurality of antennas to increase transmission rates. Accordingly, interleaver control 202 specifies what configuration tables are to be produced to the configurable frequency interleavers 206 and swizzling blocks 208 based upon transmission mode. For example, if transmission is from a single antenna of a signal stream, interleaving will be performed only upon bits of one stream.

As such, an appropriate frequency interleaver configuration table is provided to at least one of the configurable bit interleaver blocks and the swizzling blocks of FIG. 10. Alternatively, if a plurality of transmit streams are to be used for transmitting, frequency interleaver configuration table block 204 will provide the corresponding control tables to at least a corresponding plurality the configurable frequency interleavers 206 and swizzling blocks 208. As before, swizzling blocks 208 are operable to cyclicly rotate the frequency interleaved bits received from the configurable frequency interleavers 206.

Finally, each configurable frequency interleaver 206 of configurable bit interleaver block 156 and each swizzling block 208 is operably disposed to receive a control signal from frequency interleaver configuration table block 204 as well as configuration parameters for each stream. As such, according to a transmission mode of operation, the configurable frequency interleavers and swizzling blocks are flexible and can readily be adapted to interleave and swizzle bits according to a transmission mode of operation.

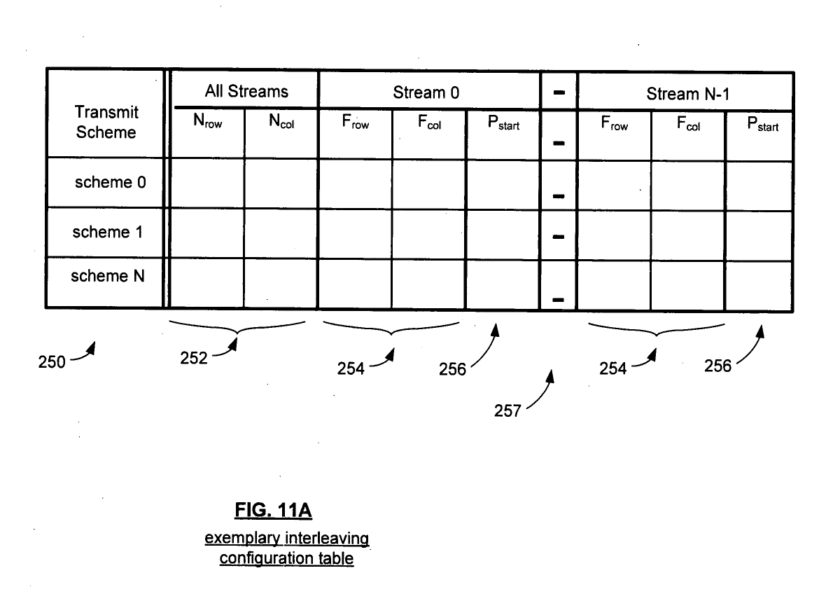

FIGS. 11A and 11B are interleaving configuration tables that illustrate two methods according to various embodiments of the present invention for performing row/column offset interleaving for a single or an OFDM transmission scheme. Referring to FIG. 11A, a leftmost column 250 is used to identify a transmission scheme. For example, each transmission scheme of an OFDM transmitter specifies whether the transmitter transmits from only one antenna, two antennas, or, for example, four antennas. For each combination of possible transmit antennas, a transmission scheme is defined therefor.

For each scheme, therefore, interleaving parameters are specified within the table. In the specific embodiment of FIG. 11A, the starting location for storing bit in an interleaving table is specified for all bit streams regardless of a transmission scheme. For example, in the prior art, the first bit of a stream is always stored in the upper leftmost comer. As such, there is no need to specify a starting coordinate for the storing of such bits. Similarly, in the prior art, the first bit that is extracted or read is from that same location. Accordingly, there is no need to specify a starting point for extracting or reading data bits. Here however, the interleaving scheme is more flexible in thus its starting location which is to be used for all streams for a given transmission scheme may be specified in columns shown generally at 252. Additionally, for each stream of a transmission scheme, a starting location for reading (extracting) the bits from the interleaving table may be specified. Thus, for a transmit scheme that has two data streams, the table of FIG. 11A allows for a starting location to be specified for both of the streams for storing bits within the interleaving table but a separate location may be specified for each of the two streams for extracting the bits. Stated differently, each stream is allowed to have its own offset value for extracting or reading the bits. The coordinates of the offset location for reading the bits and the starting phase for each stream in relation to a give transmission scheme is generally at 254.

Each stream, in one embodiment of the invention, has a specified starting swizzling phase value as shown in column 256 labeled Pₛₜₐᵣₜ. A table such as that shown in FIG. 11A includes, in the columns shown generally at 254 which specify the starting location for reading bits, a column 256 for specifying Pₛₜₐᵣₜ. This column 254 is included only for those embodiments of the invention that include the particular aspect of specifying a starting swizzling phase (as opposed to the phase always having a defined starting value such as “0” wherein the phase is purely a fuinction of the column of the interleaver table). Finally, a column 257 is shown containing a dash to indicate “n” streams and to reflect that the number of streams for which the table of FIG. 11A is used is not limited to two streams.

FIG. 11B is an exemplary interleaving configuration table that illustrates an alternate embodiment of the invention for storing bits into and for reading bits from an interleaving table. Referring now to FIG. 11B, it may be seen that each stream includes a pair of columns shown generally at 258 for defining a value for a starting location to store bits into the interleaving table as well as a pair of columns shown generally at 260 that define a starting location to read or extract bits from interleaving table. Additionally, a column 262 is shown for defining a phase operator (starting swizzling phase value). Accordingly, all parameters specified for storing and extracting bits from the interleaving table are selectable and may be specified. Thus, each stream may have different values that are specified for each stream of each scheme. It should also be pointed out, for the embodiments of FIGS. 11A and 11B, that the specification of a starting phase value is only for those embodiments in which such a phase value may be specified. For those embodiments in which the starting phase is merely a defined value, such a phase value would not be provided within the tables of FIGS. 11A and 11B and would either be a constant starting phase value or would be a function of the selected starting column or row (alternatively).

One additional aspect of FIGS. 11A and 11B includes specifying a row size of the row/column interleaver. Because of the configurable nature of the embodiments of the present invention, there is a need for an interleaver to know a row size because row sizes can be a function of the modulation scheme and the transmission scheme (SISO, MIMO, etc.). As such, one aspect of the invention includes specifying the row size in multiples of QAM symbols. As such, the row size is computer using the formula Nrow=Nrow(QAM symbol)*specified multiple of QAM symbol. As with FIG. 11A, the table of FIG. 11B may be used for any number of streams.

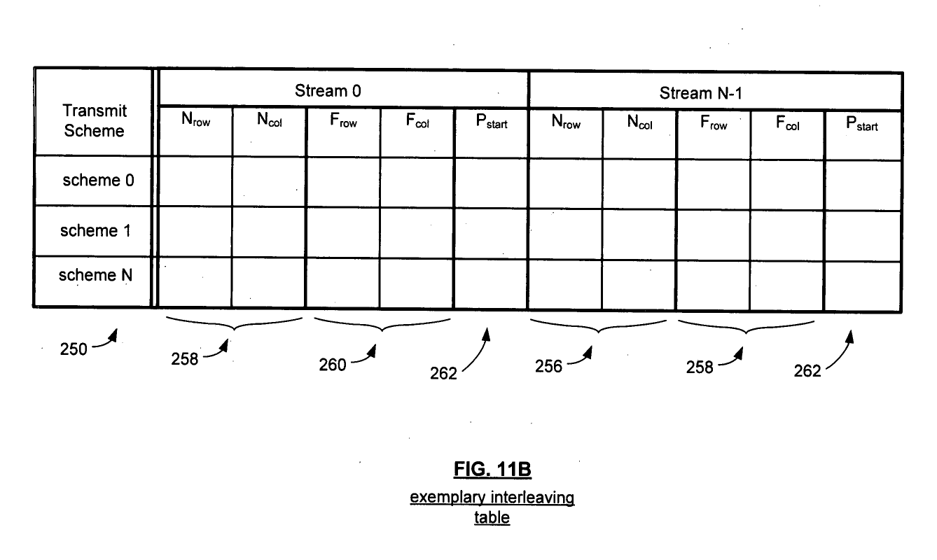

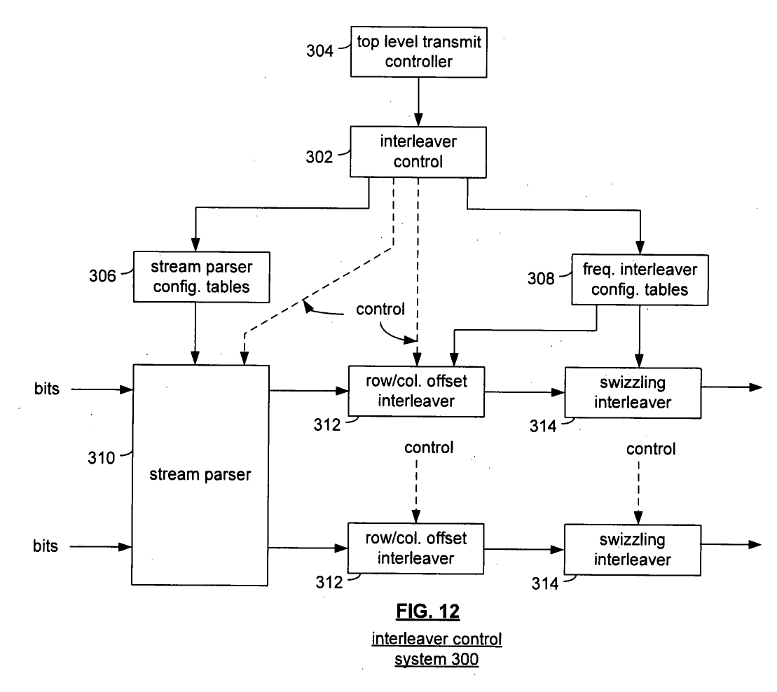

FIG. 12 is a functional block diagram of an interleaver control system according to one embodiment of the invention. As may be seen, an interleaver control system 300 includes an interleaver control block 302 that is operable to provide control signals as well as configuration signals for specifying a specified interleaving scheme based on a transmission scheme. As such, interleaver control block 302 bases its control and configuration signaling upon a received transmit mode which is received from a top level transmit controller or other logic.

In the described embodiment, the transmit mode identification is received from a top level transmit controller 304. For example, transmit controller 304 may comprise logic within transmitter processor. Interleaver control block 302 generates configuration information that is transmitted to a stream parser configuration tables block 306. Interleaver control block 302 also generates configuration information that is transmitted to frequency interleaver configuration tables 308. Stream processor configuration tables block 306 then generates appropriate configuration tables to a stream parser 310. The configuration tables generated by block 306 generally determine how may input streams are processed and how many output streams are produced.

In the example shown of FIG. 12, two streams are received and two are produced. It is understood, however, that these may readily vary and only two are shown for simplicity. Stream parser 310 is operably disposed to receive a single stream or a plurality of streams of bits for parsing. Stream parser performs such parsing based upon tables received from stream parser configuration tables block 306 and upon receiving a control signal from interleaver control block 302.

Similarly, frequency interleaver configuration tables block 308 produces configuration information to both a row/column offset interleaver 312 as well as to a swizzling interleaver 314. Row/column offset interleaver 312 performs its interleaving based upon the configuration information received from frequency interleaver configuration tables block 308 and upon a control signal received from interleaver control block 302. The interleaved output of low/column offset interleaver 312 is then produced to swizzling interleaver 314 that performs swizzling upon the interleaved data received from interleaver 312 based upon configuration information received from the frequency interleaver configuration tables block 308. For modes of operation in which stream parser 310 produces a plurality of output streams, a plurality of interleaving and swizzling blocks are utilized, one per stream, to perform the interleaving and swizzling.

FIG. 13 is a functional block diagram of a stream parser operating according to one embodiment of the present invention. In the specific example of FIG. 13, two encoders 324 and 328 each provide a digital stream to a stream parser 332 that provides an output of three parsed streams for transmission from an OFDM transmitter over three antennas. The block size for the parsing is equal to three in the described embodiment. Thus, as may be seen, a first encoder 324 produces a stream of bits shown as abc def ghi jkl to stream parser 332 while a second encoder 328 provides a bit stream of nop qrs tuv wxy to stream parser 332. Stream parser 332 then produces three out streams when a first stream (stream 0) includes bits abc nop jkl while the second stream (stream 1) includes def qrs and while the third stream (stream 2) includes bits ghi tuv.

As may be seen, stream parser 332 is flexible and operable to take input streams received from one or more encoders to provide one or more output streams when the number of output streams is not necessarily equal to the number of input streams. As such, stream parser 332 is operable to produce any one of a plurality of output streams in an OFDM transmitter according to a transmission mode independent of the number of input streams received.

Referring specifically to the first stream, it may be seen that the stream includes bits from the first encoder (abc) the second encoder (nop) and then the first encoder again (jkl). Stream one, on the other hand, includes bits from the first encoder (def) and bits from the second encoder (qrs). Similarly, stream two includes bits from the first encoder (ghi) and bits from the second encoder (tuv). Significantly, the stream parser of FIG. 13 is operable to flexibly change the number of parsed output streams based upon one or more input streams. In the described embodiment, stream parser 320 parses in the input stream(s) based upon a received configuration table and upon a control signal. Further, the number of output streams is independent of the number of input streams. As such, the stream parser of FIG. 13 may flexibly change the number of input streams is receives to parse into a specified output number of streams.

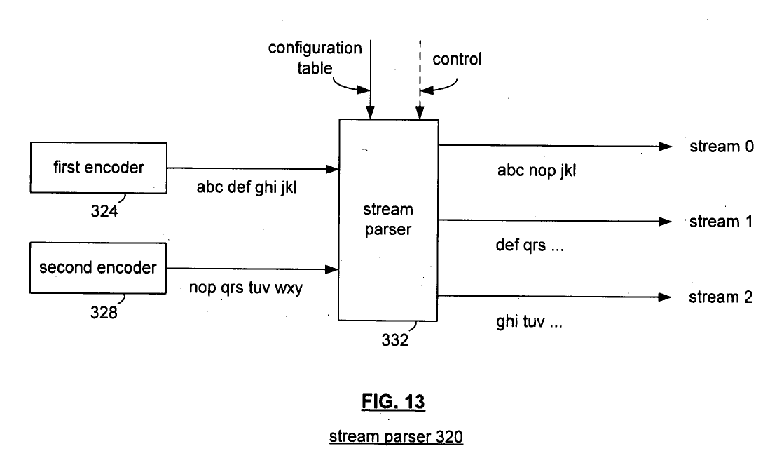

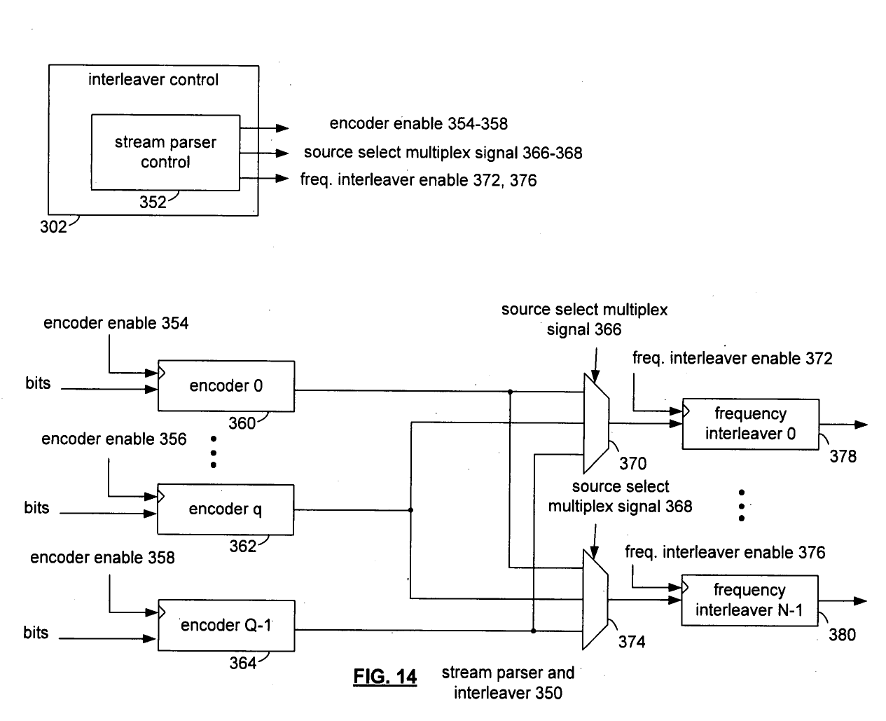

FIG. 14 is an exemplary block diagram of a stream parser and interleaver according to one embodiment of the invention. A stream parser and interleaver 350 includes logic operable to select a bit stream to bit encoded and to enable a block of bits of size S to be encoded and then produced to a frequency interleaver for a specified destination through a corresponding demultiplex circuit or device (demultiplexer or demux). Specifically, interleaver control 302 includes stream parser control logic 352 that is operable to produce encoder enable signals 354-358, source select multiplex signals 366-368, and frequency interleaver enable signals 372, 376. Stream parser control 352 produces encoder enable signals 354-358 to selectively enable one of a plurality of encoders 360-364 to encode a series of ingoing bits for a specified number of bits or block size (S).

As may be seen, each of the encoders 360-364 have commonly tied outputs that are produced as inputs to a plurality of demultiplexers 370, 374. Demultiplexers 370, 374 are operably disposed to receive source select multiplex signal 366-368 to select an encoder output of encoders 360-364 to produce the encoder output to a corresponding frequency interleaver 378-380. As such, it may be seen that stream parser control 352 is operable to select an encoder and to produce the encoded bits to a selected frequency interleaver on a bit by bit basis.

The selected frequency interleaver 378 or 380, of course, corresponds to a destination signal path. In the described embodiment of the invention, stream parser control logic 352 groups bits in blocks of size S and only switches destinations or encoder input source every “S” bits. It should be understood that the embodiment of FIG. 14 in no way is intended to limit the number of encoders used on the input side or frequency interleavers on the output side. Generally, though, the encoders will have commonly tied outputs that are produced to corresponding inputs of the demultiplexers wherein the number of demultiplexers and corresponding frequency interleavers corresponds to the number of output signal paths or antennas for a selected transmission scheme. Many more input encoders and output interleavers may be configured with the circuitry of FIG. 14 wherein, for some transmission modes or schemes, only a portion are selected to operate according to the transmission scheme of the OFDM transmitter. Generally, the configuration of FIG. 14 illustrates a destination based control wherein, for a given frequency interleaver, control signaling is generated to select the source of encoded bits for interleaving.

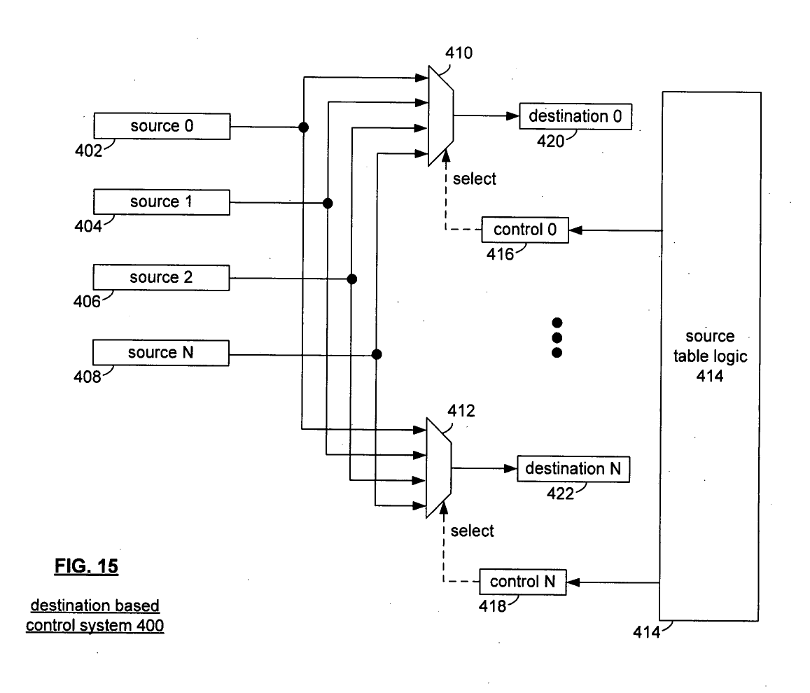

FIG. 15 is a block diagram of a destination based control system according to one embodiment of the invention. Destination based control system 400 uses source tables to provide control to switching logic for selecting sources for data to be delivered to a specified destination to be interleaved as described in relation to the various embodiments of the invention. In the specific embodiment of FIG. 15, at least four sources 402-408 shown as sources 0, 1, 2 and N are operably disposed to provide streams of data to one or more demultiplexers having commonly coupled inputs as shown in FIG. 15. Each source 402-408 is operably connected to an input of each demultiplexer 410 or 412 in the embodiment of FIG. 15. For example, source 402 (labeled source “0”) is coupled to the first input of demultiplexers 410 and 412. Source 404 is coupled to the second input of demultiplexers 410 and 412. The same pattern of connection is also found for sources 406 and 408.

Source table logic 414 provides one of control signals or switching logic tables to control logic 416 and/or 418 to select a source of data for delivery to a specified destination 420-422 according to a transmit scheme mode. As may be seen from FIG. 15, therefore, source table logic 414 is operable to select what sources provide data to a specified destination. As such, system 400 of FIG. 15 is operable to scramble data streams prior to such data streams being produced to interleaving or row/column offset interleaving circuitry and swizzling circuitry as shown in FIG. 12, for example, for further processing.

FIGS. 16A and 16B are source tables for destination based control according various embodiments of the invention. Referring to FIG. 16A, the left most columns of tables 450 and 460 identify a source for data for a given interleaver. The digits within the table reflect the selected source number (either source 0 or source 1 in this example). The horizontal direction of the tables of FIGS. 16A and 16B should be understood to represent increments in time (e.g., clock pulses). Thus, the tables represent operation in the time domain to specify source and destination parameters. The hardware that corresponds to the table of FIGS. 16A and 16B is similar to that found in FIGS. 14 and 15 except that the bits are received for a specified destination from one of two sources for one of three destinations. As may be seen, for each destination (interleaver), bits are received in groups of 3 (S=3). Referring to table 450 of FIG. 16A, table 450 specifies that source 0 is to provide three bits to destination 0. Thereafter, source 0 is to provide three bits to destination 1 and then three bits to destination 2. Thereafter, source 1 then provides bits in groups of three to each of the destinations 0, 1 and 2. Thus, the table of FIG. 16A defines switching logic that drives, for example, what demultiplexer receives a control signal specifying a source and what source is specified to the demultiplexer. For a given destination, therefore, table 450 provides data from one of two sources. It should be understood that the example of FIGS. 16A and 16B are simplified but that the concepts represented therein may readily be expanded for any number of sources or destinations.

FIG. 16B is similar to FIG. 16A except that it shows that the table may be formed with temporal overlap thereby increasing efficiency. Specifically, FIG. 16B shows an alternate embodiment in which a specified destination receives six consecutive bits (two groups of three) wherein a first group of bits are received from a first source and a second group of bits are received from a second source. At the same time the first destination receives the second group of bits, a second destination receives a first group of bits from the first source. When the second destination receives the second group of bits from the second source, the third destination (destination 2) receives a first group of bits from the first source. Finally, when the third destination receives the second group of bits, the first destination (destination 0) receives bits from the first source again. From the point, the described process repeats indefinitely.

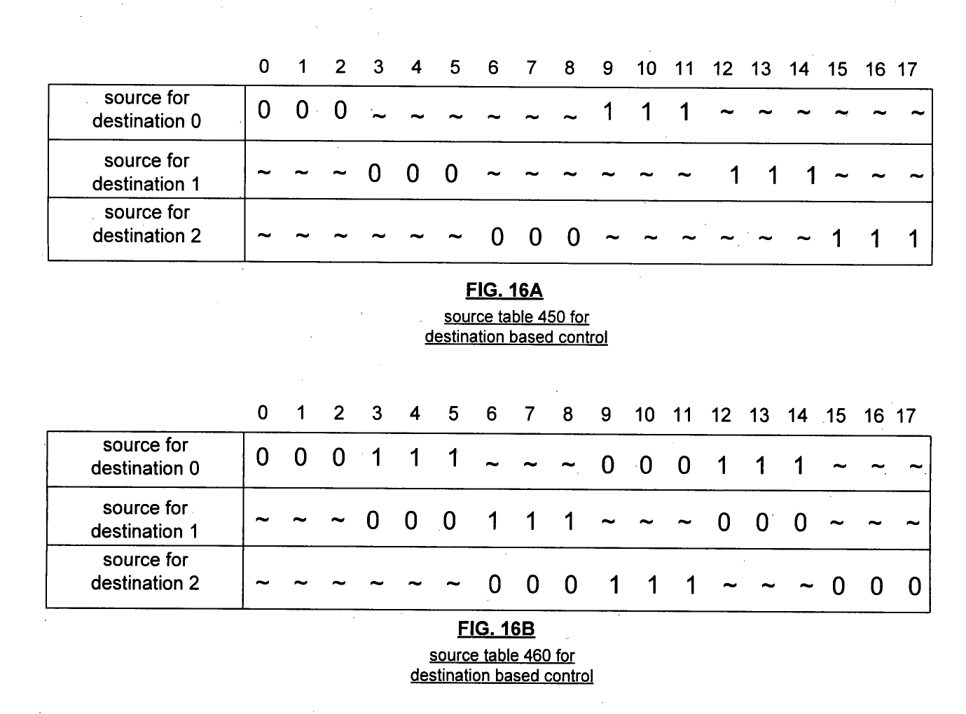

FIG. 17 is a block diagram of a source based control system according to one embodiment of the invention. Source based control system 450 uses destination tables to provide control to switching logic for selecting destinations for data from a given source to be delivered to a specified destination to be interleaved as described in relation to the various embodiments of the invention. In the specific embodiment of FIG. 17, at least four destinations 452-458 shown as destinations 0, 1, 2 and N are operably disposed to receive streams of data from a corresponding plurality multiplexers having commonly coupled outputs as shown in FIG. 17. Each destination 452-458 is operably connected to an output of each multiplexer 460 or 462. For example, destination 452 (labeled destination “0”) is coupled to the first output of multiplexers 460 and 462. Destination 454 is coupled to the second output of multiplexers 460 and 462. The same pattern of connection is also found for destinations 456 and 458.

Destination table logic 464 provides one of control signals or switching logic tables to control logic 466 and/or 468 to select a destination of data for delivery of data from sources 470-472 to a specified destination 452-458 according to a transmit scheme mode. As may be seen from FIG. 17, therefore, destination table logic 464 is operable to select what destinations receive data from a specified destination. As such, system 450 of FIG. 17 is operable to scramble data streams prior to such data streams being produced to interleaving or row/column offset interleaving circuitry and swizzling circuitry as shown in FIG. 12, for example, for further processing.

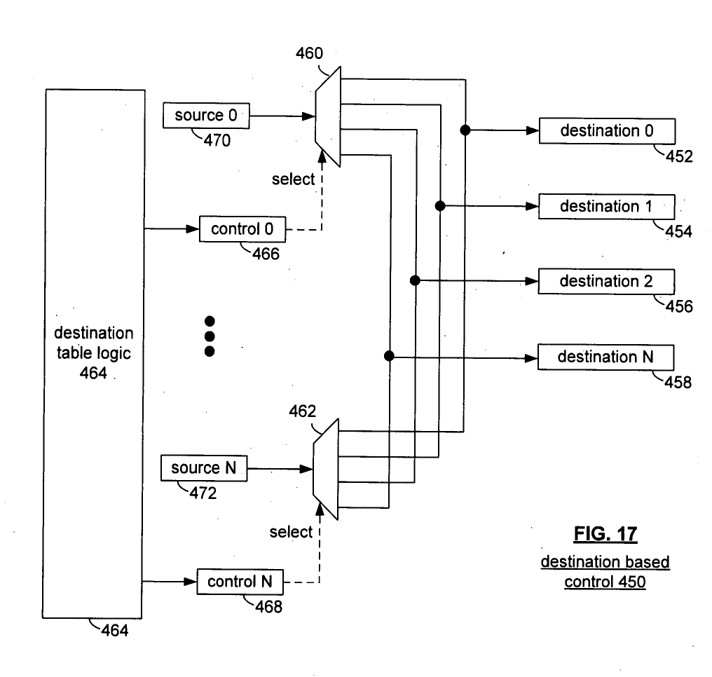

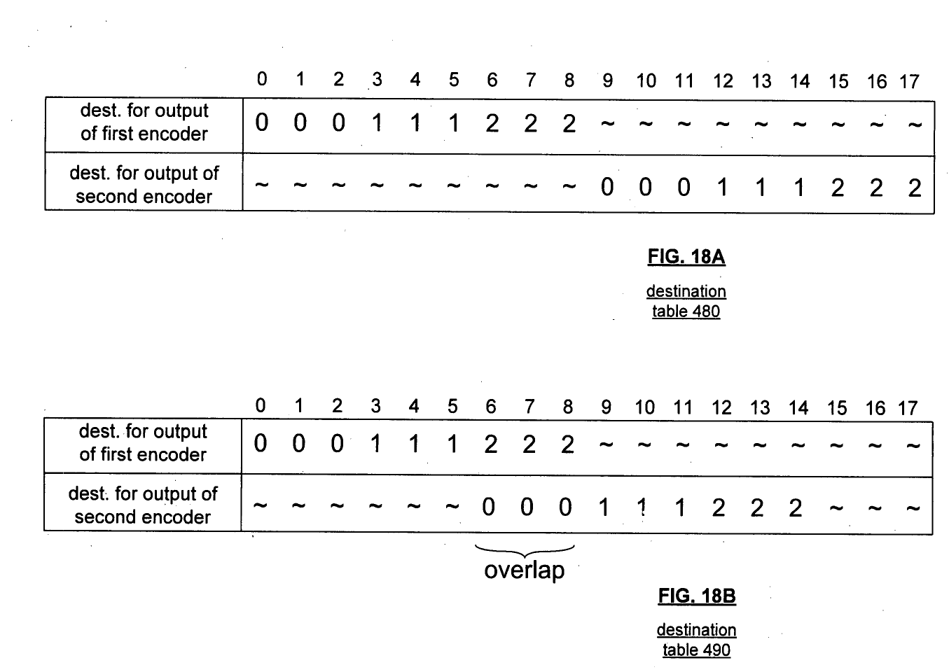

FIGS. 18A and 18B are destination tables for destination based control according various embodiments of the invention. Referring to FIG. 18A, the left most columns of tables 480 and 490 identify a destination for data (e.g., an interleaver). The digits within the table reflect the selected source number (either source 0, source 1 or source 2 in this example). The hardware that corresponds to the table of FIGS. 18A and 18B is similar to that found in FIG. 17 except that the bits in the examples of FIGS. 18A and 18B are received for a specified destination from one of three sources for one of two destinations. As may be seen, for each destination, bits are received in groups of 3 (S=3). Referring to table 480 of FIG. 18A, table 480 specifies that source 0 is to provide three bits to destination 0. Thereafter, source 1 and then source 2 provide three bits to destination 0. Thereafter, sources 0, 1 and 2 each deliver three bits to destination 1. Thus, the table of FIG. 18A defines switching logic that drives, for example, what multiplexer receives a control signal is specifying a destination for a given source. For a given destination, therefore, table 480 provides data from one of three sources. It should be understood that the example of FIGS. 18A and 18B are simplified but that the concepts represented therein may readily be expanded for any number of sources or destinations.

FIG. 18B is similar to FIG. 18A except that it shows that the table may be formed with overlap thereby increasing efficiency. Specifically, FIG. 18B shows an alternate embodiment in which a specified destination receives nine consecutive bits (three groups of three from sources 0, 1 and 2). At the same time the first destination receives the third group of bits, a second destination receives a first group of bits from the first source. From the point, the described process repeats indefinitely.

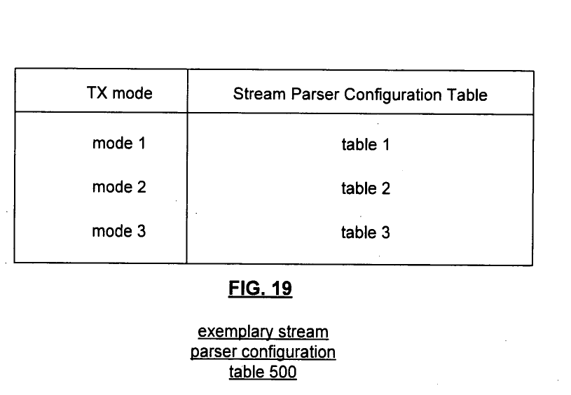

FIG. 19 is an exemplary stream parser configuration table according to one embodiment of the invention. FIG. 19 specifically illustrates the concept that a plurality of stream parser configuration tables may be defined. Which table is used is based upon a transmit scheme or mode of operation. Generally, a table is identified for every type of transmit scheme and is used for parsing based upon the transmit mode or scheme.

FIG. 20 is a flow chart that illustrates a method for interleaving according to one embodiment of the invention. Initially, received bits are stored into an interleaving table by row and then by column at a selectable starting point (step 510). Thereafter, beginning at a selectable offset position, extracting bits sequentially by column and then by row (step 514). The extracted bits, which are interleaved and frequency rotated, are swizzled (cyclicly rotated) a specified number of times for a specified group size (step 516).

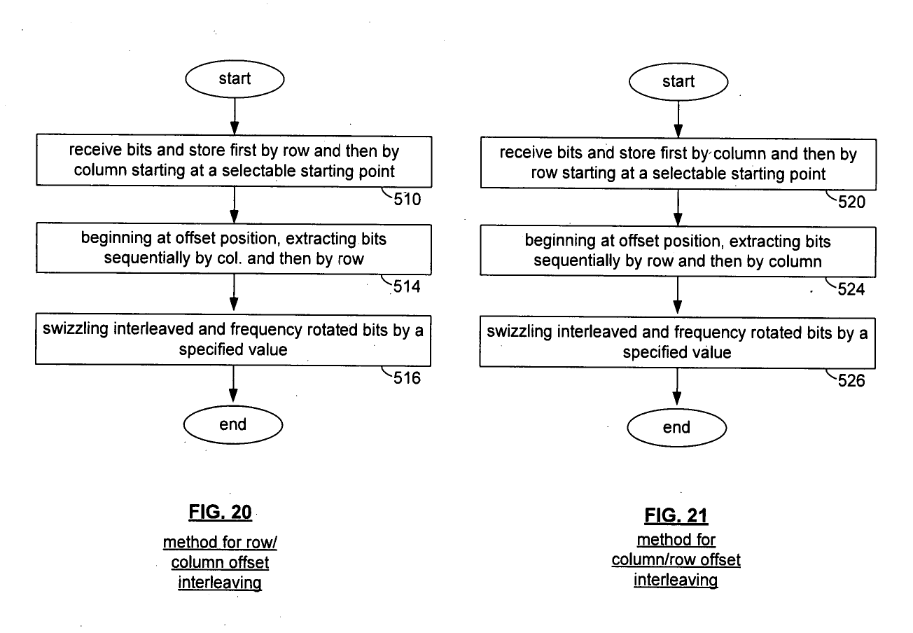

FIG. 21 is a flow chart that illustrates a method for interleaving according to one embodiment of the invention. Initially, received bits are stored into an interleaving table by column and then by row at a selectable starting point (step 520). Thereafter, beginning at a selectable offset position, the bits are extracted (read) sequentially by row and then by column (step 524). The extracted bits, which are interleaved and frequency rotated, are swizzled (cyclicly rotated) a specified number of times for a specified group size (step 526). This embodiment further includes starting the swizzling phase (number of times the bits are rotated) at a selectable and specified value).

For both methods described in relation to FIGS. 20 and 21, it is understood that the method steps may readily be combined with any and all other processes described herein including the parsing which is dependent upon a transmit mode or scheme. Further, the methods of FIGS. 20 and 21 may also be combined with flexible interleaving schemes that are also transmit mode dependent. Finally, while the methods of FIGS. 20 and 21 included complete flexibility in that starting positions for storing bits, offset positions in the table may be selectable and specified by logic, swizzling phase may be selectable and specified by logic, other embodiments have less flexibility. For example, in one embodiment, the starting position is not selectable by logic and is always the same specified position. In another embodiment, the offset position in the table is not selectable and remains constant. In yet another embodiment, the starting swizzling phase is always a specified value (e.g., 0 meaning there is no rotation initially).

As one of ordinary skill in the art will appreciate, the term “substantially” or “approximately”, as may be used herein, provides an industry-accepted tolerance to its corresponding term and/or relativity between items. Such an industry-accepted tolerance ranges from less than one percent to twenty percent and corresponds to, but is not limited to, component values, integrated circuit process variations, temperature variations, rise and fall times, and/or thermal noise. Such relativity between items ranges from a difference of a few percent to magnitude differences. As one of ordinary skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled”.

While the invention is susceptible to various modifications and alternative forms, specific embodiments thereof have been shown by way of example in the drawings and detailed description. It should be understood, however, that the drawings and detailed description thereto are not intended to limit the invention to the particular form disclosed, but, on the contrary, the invention is to cover all modifications, equivalents and alternatives falling within the spirit and scope of the present invention as defined by the claims. As may be seen, the described embodiments may be modified in many different ways without departing from the scope or teachings of the invention.

1. A system for interleaving an outgoing data stream, comprising:
a transmit controller operable to produce an indication of a transmission mode;
an interleaver controller operable to generate stream parser table selection signaling and frequency interleaver configuration table selection signaling;
stream parser configuration table logic operable to produce a stream parser configuration table based upon the stream parser table selection signaling;
frequency interleaver configuration table logic operable to provide a frequency interleaver configuration table; and
wherein a stream parser, a row/column interleaver and a swizzling interleaver are each operable to configurably parse and interleave received bit streams based upon the stream parser configuration table and the frequency interleaver configuration table, respectively.

2. The system of claim 1 wherein the stream parser also receives a parser control signal from the interleaver control wherein the stream parser parses based upon control pulses received as the control signal.

3. The system of claim 1 wherein the row/column interleaver receives an interleaver control signal from the interleaver control wherein the row/column interleaver interleaves a received bit stream based upon the interleaver control signal.

4. The system of claim 1 wherein the row/column interleaver is a row/column offset interleaver.

5. The system of claim 1 wherein the frequency interleaver configuration table specifies an offset starting location, comprising a defined row and column location, for extracting bits from an interleaving table for each MIMO stream.

6. The system of claim 1 wherein the frequency interleaver configuration table specifying an offset starting location, comprising a defined row and column location, for extracting bits from an interleaving table for each type of transmission scheme.

7. The system of claim 1 wherein the frequency interleaver configuration table wherein an offset starting location, comprising a defined row and column location, for extracting bits from an interleaving table is specified for each MIMO stream for each type of transmission scheme.

8. The system of claim 1 wherein the frequency interleaver configuration table wherein a starting location, comprising a defined row and column location, for storing bits into an interleaving table is specified for each MIMO stream.

9. The system of claim 1 wherein the frequency interleaver configuration table wherein a starting location, comprising a defined row and column location, for storing bits into an interleaving table starting row is specified for each type of transmission scheme.

10. The system of claim 1 wherein the frequency interleaver configuration table wherein a starting location, comprising a defined row and column location, for storing bits into an interleaving table is specified for each MIMO stream for each type of transmission scheme.

11. The system of claim 1 wherein a starting location, comprising a defined row and column location, for storing bits into an interleaving table is specified for each stream but is common for all transmission schemes and wherein an offset starting location, comprising a defined row and column location, for extracting bits from an interleaving table is specified for each MIMO stream and for each type of transmission scheme.

12. The system of claim 1 wherein the stream parser configuration table is operably configured to provide destination based control wherein one source provides bits in a specified group size to each of a plurality of parser destinations in a temporally sequential manner.

13. The system of claim 1 wherein stream parser configuration table is operably configured to provide destination based control wherein one source provides bits in a specified group size to each of a plurality of parser destinations in a temporally overlapping manner.

14. The system of claim 1 wherein the stream parser configuration table is operably configured to provide source based control wherein one destination receives bits in a specified group size from a plurality of parser sources in a temporally non-overlapping manner.

15. The system of claim 1 wherein the stream parser configuration table is operably configured to provide source based control wherein one destination receives bits in a specified group size from a plurality of parser sources in a temporally overlapping manner.

16. A stream parser, comprising:
stream parser block operably disposed to receive a stream parser configuration table and a stream parsing control signal;
a first plurality of inputs coupled to receive a second plurality of bits streams wherein the second plurality is based upon a transmission mode of operation and wherein the second plurality is less than or equal to the first plurality;
a third plurality of outputs for producing a fourth plurality of bits streams wherein the fourth plurality is based upon the transmission mode of operation and wherein the fourth plurality is less than or equal to the third plurality.

17. The stream parser of claim 16 wherein the stream parser configuration table corresponds to the transmission mode of operation and specifies what inputs are to be used to receive bit streams.

18. The stream parser of claim 16 wherein the stream parser configuration table corresponds to the transmission mode of operation and specifies what outputs are to be used to produce outgoing bit streams.

19. The stream parser of claim 16 wherein the stream parser configuration table corresponds to the transmission mode of operation and specifies a mapping of inputs to outputs and wherein the control signal prompts a sequential stepping through the stream parser configuration table to achieve a desired stream parsing result.

20. A method for interleaving a digital bit stream arranged in a table characterized by Nrow rows and Ncol columns, comprising:
receiving bits of the digital bit stream and storing the bits sequentially row and then by column wherein each row is completely filled beginning at a specified starting point for the row prior to storing bits in a parallel row;
simultaneously interleaving column and row bits in the table and frequency rotating interleaved bits by:
determining a row and column offset value for the table; and
beginning at a location specified by the offset value, extracting bits sequentially by column and then by row wherein the bits column starting at a specified beginning point for the column are extracted prior to extracting bits of a parallel column; and
swizzling interleaved and frequency rotated data bits extracted from the table.

21. The method of claim 20 further including swizzling the interleaved and frequency rotated data bits extracted from the table according to a selectable specified phase value.

22. Circuitry for interleaving a digital bit stream, comprising:
logic for creating a table in memory characterized by Nrow rows and Ncol columns;
circuitry for receiving bits of a digital bit stream and for storing the bits sequentially in a table according to a first tabular order;
logic to prompt the circuitry to simultaneously interleave column and row bits in the table and to frequency rotate the interleaved bits by:
circuitry for determining a row and column offset value for the table; and
circuitry for extracting bits sequentially according to a second tabular order beginning at an offset location specified by the offset value; and
circuitry for swizzling interleaved and frequency rotated data bits extracted from the table.

23. The circuitry of claim 22 further including swizzling the interleaved and frequency rotated data bits extracted from the table according to a specified phase value.

24. The circuitry of claim 23 wherein the swizzling phase is based upon a column from which bits are extracted.

25. The circuitry of claim 24 wherein the swizzling phase is specified directly by the column from which the bits are extracted.

26. The circuitry of claim 24 wherein the swizzling phase is based upon a starting phase value that is specified by logic and wherein the swizzling phase is incremented to a subsequent phase value whenever the column for extracting bits changes.
